(19) United States
(12) Patent Application Publication
(10) Pub. No.: US 2018/0197130 A1
(43) Pub. Date: Jul. 12, 2018

(54) SYSTEMS AND METHODS FOR DETERMINING INVENTORY DEMANDS OF NEWLY OPENED STORES

(71) Applicant: Wal-Mart Stores, Inc., Bentonville, AR (US)

(72) Inventors: Cristy C. Brooks, Cassville, MO (US); Greg A. Bryan, Centerton, AR (US); David Blair Brightwell, Bentonville, AR (US); Benjamin D. Enssle, Bella Vista, AR (US)

(21) Appl. No.: 15/865,511

(22) Filed: Jan. 9, 2018

Related U.S. Application Data
(60) Provisional application No. 62/443,893, filed on Jan. 9, 2017.

(51) Int. Cl. G06Q 10/06; G06Q 10/08

(52) U.S. Cl. CPC G06Q 10/06315; G06Q 10/083; G06Q 10/087

(57) ABSTRACT

In some embodiments, apparatuses and methods are provided herein useful to estimating and adjusting initial inventory demands at new shopping facilities based on real time sales data. In some embodiments, there is provided a system including: a new shopping facility database including demographic and geographic data about a new shopping facility; an existing shopping facility database including demographic, geographic, and historic sales data at existing shopping facilities; real time inventory data including sales at the new shopping facility after opening; and a central computing system identifying an existing shopping facility with similar demographic and geographic data to the new shopping facility; determining the historic sales at the existing shopping facility; calculating a first estimate of inventory demand for merchandise items at the new shopping facility; and calculating a second estimate of inventory demand for the merchandise items at the new shopping facility based on real time inventory data.

### CROSS-REFERENCE TO RELATED APPLICATION

This application claims the benefit of U.S. Provisional Application No. 62/443,893, filed Jan. 9, 2017, which is incorporated herein by reference in its entirety.

### TECHNICAL FIELD

This invention relates generally to estimating inventory demands, and more particularly, to estimating inventory demands of merchandise items at newly opened stores.

### BACKGROUND

One important aspect in the retail setting is accurately estimating the inventory demands for merchandise items at stores. Inventory demands can vary based on a number of factors, including, for example, the demographic make-up around the store, the geographic region of the store, seasonality, and purchase trends. If the estimate is too low, the store may experience lost sales by not having a sufficient quantity of a merchandise item. If the estimate is too high, the store may have too much inventory on hand and may have to determine how to dispose of it.

This challenge of estimating inventory demands is even more difficult for newly opened stores. These stores do not have a historical record of sales that they can use to estimate inventory demands. It is desirable to adjust an in initial estimate of inventory demand at a newly opened store based on real time data.

### BRIEF DESCRIPTION OF THE DRAWINGS

Disclosed herein are embodiments of systems, apparatuses and methods pertaining to estimating and adjusting initial inventory demands at new shopping facilities based on real time sales data. This description includes drawings, wherein:

FIG. 1 is a block diagram in accordance with some embodiments; and

FIG. 2 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to estimating and adjusting initial inventory demands at new shopping facilities based on real time sales data. In some embodiments, there is provided a system including: a new shopping facility database including demographic and geographic data corresponding to the area about a new shopping facility; an existing shopping facility database including demographic, geographic, and historic sales data corresponding to existing shopping facilities; real time inventory data including data regarding the sales of at least one predetermined merchandise item at the new shopping facility within a predetermined time period after opening of the new shopping facility; a central computing system communicatively coupled to the new shopping facility, existing shopping facility, and sales databases, the central computing system configured to: access the demographic and geographic data corresponding to the new shopping facility and corresponding to the existing shopping facilities; compare the demographic and geographic data corresponding to the new shopping facility with the demographic and geographic data corresponding to existing shopping facilities; identify at least one existing shopping facility with similar demographic and geographic data to the new shopping facility; determine the historic sales for the at least one predetermined merchandise item at the at least one existing shopping facility; calculate a first estimate of inventory demand for the at least one predetermined merchandise item at the new shopping facility based on the determination; and calculate a second estimate of inventory demand for the at least one predetermined merchandise item at the new shopping facility based on the real time inventory data.

In one form, in the system, the existing shopping facility database may include data from a plurality of shopping facilities corresponding to one retail sales entity. Further, the central computing system may be configured to adjust the first estimate based on the sales of at least one of competing and non-competing shopping facilities in the geographic region about the new shopping facility. In addition, the central computing system may be configured to adjust the first estimate based on at least one of the general market, sales trends, and seasonal inventory demands for the geographic region about the new shopping facility. Also, the central computing system may be configured to adjust the first estimate based on the distribution network for delivery of merchandise items for the geographic region about the new shopping facility. Moreover, the central computing system may be configured to adjust the first estimate based on the physical size of the new shopping facility. Further, the predetermined time period after opening of the new shopping facility may be three days or less.

In one form, the calculation of the second estimate may include adjusting the first estimate based on the sales of the at least one merchandise item at the new shopping facility within the predetermined time period after opening of the new shopping facility. In addition, the central computing system may be configured to, if the second estimate is greater than first estimate, instruct an increase of incoming shipments of inventory for the at least one predetermined merchandise item. Moreover, the central computing system may be configured to, if the second estimate is less than the first estimate, instruct a reduction of incoming shipments of inventory for the at least one predetermined merchandise item.

In another form, there is provided a method for estimating and adjusting initial inventory demands at new shopping facilities based on real time sales data, the method including: storing in a new shopping facility database demographic and geographic data corresponding to the area about a new shopping facility; storing in an existing shopping facility database demographic, geographic, and historic sales data corresponding to existing shopping facilities; determining real time inventory data regarding the sales of at least one predetermined merchandise item at the new shopping facility within a predetermined time period after opening of the new shopping facility; by a central computing system: accessing the demographic and geographic data corresponding to the new shopping facility and corresponding to the existing shopping facilities; comparing the demographic and geographic data corresponding to the new shopping facility with the demographic and geographic data corresponding to existing shopping facilities; identifying at least one existing shopping facility with similar demographic and geographic data to the new shopping facility; determining the historic sales for the at least one predetermined merchandise item at the at least one existing shopping facility; calculating a first estimate of inventory demand for the at least one predetermined merchandise item at the new shopping facility based on the determination; and calculating a second estimate of inventory demand for the at least one predetermined merchandise item at the new shopping facility based on the real time inventory data.

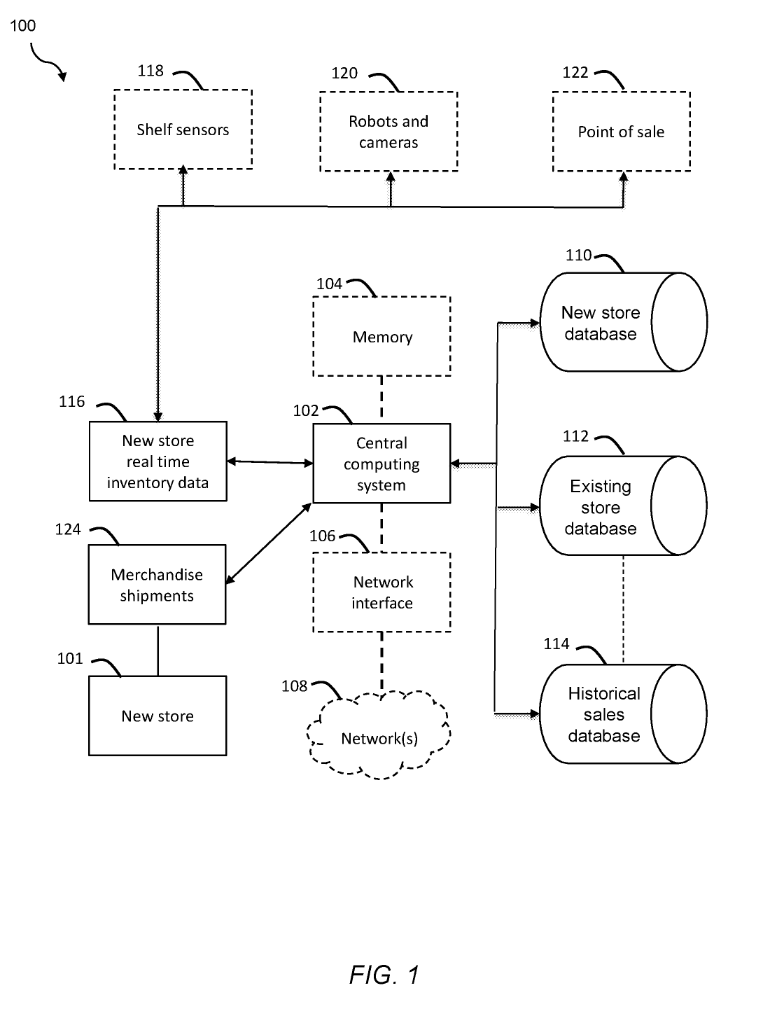

FIG. 1 is a block diagram illustrating components of a system 100. As addressed further below, the system 100 provides an approach for determining an accurate estimate of merchandise and inventory demands at newly opened stores. The system 100 uses historical sales information for sister stores with a similar geographic and/or demographic make-up to generate an initial estimate. However, this estimate is recalculated based on real time sales data from the newly opened store immediately after opening.

As addressed in more detail below, the system 100 evaluates multiple factors in determining the inventory to be supplied in initially stocking a new store 101 and in at least a set of first replenishment orders. The system 100 uses demographic information of the area around the new store 101 and the geographic region where the new store 101 is. Based on this information, the system 100 identifies one or more primary sister stores that have similar demographic data in a similar geographic region (which can be in a completely different part of the country). The historic sales for the primary sister store(s) may be used as an input in determining forecasted sales. A number of other factors may also be considered, including sales estimates and/or data at competitive and non-competing stores within the geographic area of the new store 101. The system 100 may further take into consideration the general market for the demographic and the geographic region, as well as sales trends and seasonality in the forecasting. The system 100 can further consider the distribution network regarding how long it is predicted to take for products to be distributed to the new store 101 (e.g., longer delivery times can result in ordering larger numbers to avoid running out before subsequent deliveries). The system 100 evaluates these inputs in forecasting sales at the new store 101, and uses the forecasted sales to identify an initial inventory and quantities of that inventory for the new store 101, as well as the first set of replenishment shipments.

However, it has been found that this initial estimate may not be entirely accurate because of the uncertainty of inventory demand associated with a completely new store 101. This system 100 therefore calculates real time sales data immediately after opening of the new store 101 in any of various ways, as addressed further below. This real time sales information allows adjustment and recalculation of the initial estimate to a more accurate merchandise and inventory estimate. Based on this recalculated estimate, merchandise deliveries to the new store 101 can be reevaluated and, if necessary, rerouted.

The system 100 includes a central computing system 102 that is communicatively coupled to several databases, as addressed further below. The central computing system 102 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the central computing system 102 to effect the control aspect of these teachings.

Such a central computing system 102 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This central computing system 102 is configured (for example, by using corresponding programming as will be well understood by those skilled in the art) to carry out one or more of the steps, actions, and/or functions described herein.

By one optional approach, the central computing system 102 operably couples to a memory 104. This memory 104 may be integral to the central computing system 102 or can be physically discrete (in whole or in part) from the central computing system 102, as desired. This memory 104 can also be local with respect to the central computing system 102 (where, for example, both share a common circuit board, chassis, power supply, and/or housing) or can be partially or wholly remote with respect to the central computing system 102 (where, for example, the memory 104 is physically located in another facility, metropolitan area, or even country as compared to the central computing system 102).

This memory 104 can serve, for example, to non-transitorily store the computer instructions that, when executed by the central computing system 102, cause the central computing system 102 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the central computing system 102 also operably couples to a network interface 106. So configured, the central computing system 102 can communicate with other elements (both within the system 100 and external thereto) via the network interface 106. Network interfaces, including both wireless and non-wireless platforms, are well understood in the art and require no particular elaboration here. This network interface 106 can compatibly communicate via whatever network or networks 108 may be appropriate to suit the particular needs of a given application setting. Both communication networks and network interfaces are well understood areas of prior art endeavor and therefore no further elaboration will be provided here in those regards for the sake of brevity.

The central computing system is communicatively coupled to a new store database 110, an existing store database 112, and a historical sales database 114. The new store database 110 (or new shopping facility database) includes demographic and/or geographic data corresponding to the area about the new shopping facility 101. Essentially, it includes information about the neighborhood about the new store. So, for example, it may include data of the age groups of people living in the neighborhood, i.e., the data may show that 50% of people in the neighborhood are in the 20-30 year old age group.

The system 100 also includes an existing store database 112 (or existing shopping facility database), which includes geographic and/or demographic data corresponding to existing shopping facilities. These existing stores/shopping facilities may be stores operated by a retailer that also operates the newly opening store 101. So, for example, this existing store database 112 may include the data of age groups of people living in the neighborhoods about these existing stores. The existing store database 112 may be searched for existing stores that have a similar demographic make-up, i.e., 50%, of people in the 20-30 year age group. As should be evident, the existing store database 112 could be searched on the basis of any desired demographic/geographic criteria (or combination of criteria) to match existing stores to the newly opened store 101. A number of different algorithms may be used that assign varying weights to different criteria to try to determine one or more existing stores that are the closest match to the newly opening store 101. It is generally contemplated that existing stores (or sister stores) with similar geographic/demographic characteristics as a newly opening store 101 will serve as good predictors of the inventory demands for the newly opening store 101.

It should be evident that the geographic and/or demographic data for new and/or existing stores may be collected from a variety of sources. In one form, it is contemplated that some or all of the data may be gathered internally by a retailer from its own existing databases. However, in another form, it is contemplated that some or all of the geographic and demographic data may also be inputted by third party data providers. Some or all of the data may be collected from public databases that have geographic and/or demographic data for specific neighborhood(s) corresponding to the new and/or existing stores. In other words, this disclosure is not limited to geographic and/or demographic data from any particular source, given that a variety of sources often collect such data.

The system 100 further includes a historical sales database 114 that includes data showing past sales/quantity of merchandise sold. This database 114 may be a distinct database or may be a part of or a sub-database of the existing store database 112. So, in one form, it is contemplated that, after similar existing stores(s) are identified as a match for the newly opening store 101, the historical sales data of these similar existing store(s) will be used as the basis for an initial estimate of the inventory demands for the merchandise at the newly opening store 101. The historical sales data will provide an initial estimate of the type and amount of merchandise that may be stocked at the newly opening store 101.

In other words, the central computing system 102 is configured to calculate an initial estimate of inventory demands at the newly opening store 101. The central computing system 102 accesses the demographic and/or geographic data corresponding to the new shopping facility 101 and corresponding to the existing shopping facilities. It compares certain demographic and geographic data corresponding to the new shopping facility 101 with certain demographic and geographic data corresponding to existing shopping facilities. Then, it identifies at least one existing shopping facility with similar demographic and/or geographic data to the new shopping facility, i.e., it identifies a close match. The central computing system 102 determines the historical sales for merchandise item(s) at the existing shopping facility(ies) and calculates an initial estimate of inventory demand for the merchandise item(s) at the new shopping facility 101 based on the historical sales determination.

In one form, it is generally contemplated that this initial estimate may be revised based on other factors available prior to the opening of the new store 101. It has been found that this initial estimate may provide a rough general estimate but that additional factors may improve this estimate. It has been found that, without these additional factors, the initial estimate may be too high, resulting in overstock and too much initial freight to the new store. Further, the initial estimate can be compared to the holding capacity of the store as a sort of error check, and the initial estimate can be revised if it exceeds this holding capacity.

As a first example of an additional factor, the initial estimate may be adjusted based on competing and/or noncompeting stores in the region near the newly opening store 101. In other words, the central computing system 102 may be configured to adjust the initial estimate based on the sales of at least one of competing and non-competing shopping facilities in the geographic region about the new shopping facility 101. The retailer may have other stores in the area such that there may be an overlap in customers, which may lead to a reduction in the initial estimate. In addition, there may be nearby competing and/or noncompeting stores operated by a retailer different than the one operating the newly opening store 101.

As a second example, the initial estimate may be adjusted based on factors like the general market, sales trends, and seasonality. In other words, the central computing system 102 may be configured to adjust the initial estimate based on at least one of the general market, sales trends, and seasonal inventory demands for the geographic region about the new shopping facility 101. So, for instance, the general market and sales trends may be evaluated and may show that certain types of merchandise (such as fresh produce) are especially desirable in the particular geographic region about the newly opening store 101, and seasonality (such as the new store 101 opening in the fall season) may increase the demand for certain types of merchandise (such as back-to-school clothing for children). The initial estimates for these types of merchandise may then be adjusted accordingly.

As a third example, the initial estimate may be adjusted based on the nature of the distribution network and the ease of delivery of merchandise to the new store 101. In other words, the central computing system 102 may be configured to adjust the initial estimate based on the distribution network for delivery of merchandise items for the geographic region about the new shopping facility 101. For instance, it may be desirable to order a large quantity of a certain type of merchandise item because long delivery times for that merchandise item can result in running out before subsequent deliveries of the merchandise item arrive.

As a fourth example, the initial estimate may be adjusted based on the physical size of new shopping facility 101. In other words, the central computing system 102 may be configured to adjust the initial estimate based on the physical size of the new shopping facility 101. If the new store 101 is larger than the similar existing store(s) determined to be a close match, the inventory/merchandise may be adjusted upward based on the ability of the new store 101 to accommodate more inventory and/or to accommodate more customers at a given time.

It should be understood that the initial estimates of inventory demands may be adjusted by one or more of these factors. In one form, the initial estimates may be generated based on the historical sales for similar existing stores found to be a close match to the newly opening store 101. This initial estimates may then be adjusted upward or downward for different types of merchandise items. Different algorithms assigning different weights to the various factors may be applied to make adjustments to the initial estimates.

It is contemplated that this initial estimate is then adjusted based on real time inventory data 116 available immediately following the opening of the new store 101. The real time inventory data 116 reflects the sales of merchandise items at the new shopping facility 101 within a short specific time period after opening of the new shopping facility 101. In other words, the central computing system 102 is configured to calculate a second estimate of inventory demand for the merchandise items at the new shopping facility 101 based on the real time inventory data 116.

In one form, it is generally contemplated that the real time inventory data 116 may be collected in various ways. As a first example, the real time inventory data 116 for some or all of the merchandise items may be collected from shelf sensors 118. In one form, the shelf sensors 118 may be arranged on the shelves to measure weight/pressure. For instance, in one form it is contemplated that the sensor 118 on an individual shelf may include multiple weight sensors, or pressure-sensitive sensors, that detect the weight of the merchandise on the shelf. In one form, the sensor 118 on a shelf may be arranged as multiple individual sensor strips extending along the shelf's bottom surface and defining a sensing grid or matrix. In one form, these sensor strips may have sufficient discrimination and resolution so as to identify the quantity of merchandise on the shelf.

As a second example, the sensors 120 may be arranged or moving about the new store 101, instead of or in addition to being mounted at the shelf. For instance, in one form, the sensor 120 may be some sort of camera or video apparatus for capturing images of the merchandise/inventory on the shelves. In another form, the sensor 120 may be an autonomous or semi-autonomous portable robot scanning device that may be supported by wheels and move up and down the aisles of the new shopping facility 101. The portable robot scanning device 120 may include some sort of reader for reading the identification data at the shelf. In this form, as the portable robot scanning device 120 moves up and down the aisles, it may be configured to direct its reader so that it collects identification data from all of the shelves that its reader is facing. The reader and identification data may any of various types, such as, for example, a barcode reader, an RFID reader, an NFC reader, a laser imager, an optical sensor, an image recognition device, or a text capture device. In this manner, the sensors 120 may determine the quantity of merchandise on the shelves.

As a third example, the real time inventory data 116 may be in the form of sales data gathered at points of sales 122. In one form, the sales data corresponding to various merchandise items may be collected and stored in a sales database, indicating the quantity of merchandise purchased and the change in inventory. It should also be evident that a combination of shelf sensors 118, store sensors 120, and points of sales 122 may be used to determine real time inventory data 116, and different approaches may be used for different types of merchandise items. In addition, a combination of shelf sensors 118, store sensors 120, and/or points of sales 122 approaches may be used in a redundant manner to verify the real time inventory data determinations.

In one form, it is contemplated that this real time inventory data 116 is collected within a certain amount of time immediately after the opening of the new store 101. The real time inventory data 116 must be gathered within a short window of time to generate the second estimate(s) of merchandise items in order to provide sufficient opportunity to take action based on the second estimates, such as, without limitation, rerouting or redirecting delivery vehicles containing some of the merchandise items. This short window of time is generally within the first few days after the new store's opening, and in one form, should not be longer than a week or three days after opening. The calculation of the second estimate generally includes adjusting the first estimate based on the real time sales of the merchandise items at the new shopping facility 101 within the predetermined time period after opening of the new shopping facility 101.

As stated, one type of action that may be undertaken based on the second estimate is the rerouting of merchandise shipments 124 of delivery vehicles. In other words, shipments 124 of inventory may be increased or decreased based on the real time inventory data 116. In one form, the central computing system 102 may be configured to, if the second estimate is greater than the first estimate for a merchandise item, instruct an increase of incoming shipments 124 of inventory for that particular merchandise item. Alternatively, the central computing system 102 may be configured to, if second estimate is less than the first estimate for a particular merchandise item, instruct a reduction of incoming shipments 124 of inventory for that particular merchandise item. Deliveries with affected merchandise may be redirected from or to other stores.

Generally, stocking of the new store may involve ordering an initial inventory and the first few replenishments of certain inventory. By collecting the real time inventory data immediately after the new store 101 opens, adjustments can be made to merchandise that may already be inbound to the new store 101. For example, merchandise for the next two weeks after opening is frequently already in the process of delivery. By acting upon the real time inventory data within a short time after opening, the new store 101 can potentially avoid overstock by diverting the incoming deliveries to a different store, such as to a high sales volume store.

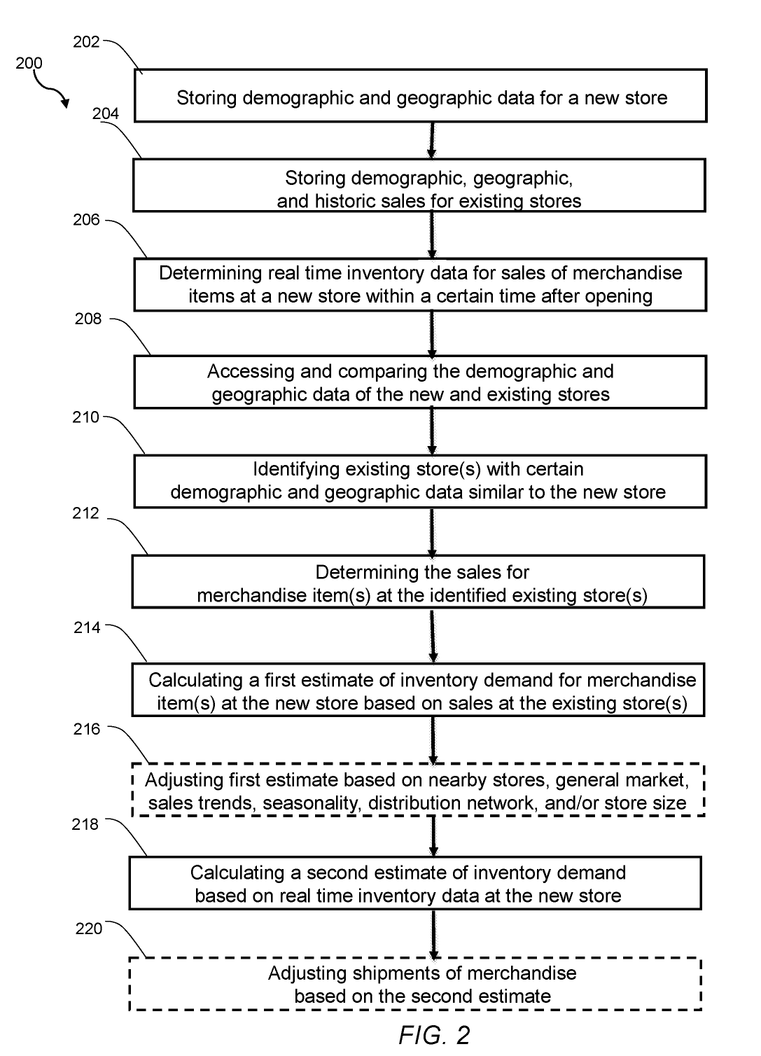

Referring to FIG. 2, there is shown a process 200 for calculating inventory demands at a newly opened store. The process 200 generally includes calculating a first estimate of inventory demand based on historic sales of merchandise at similar existing stores. This first estimate may be adjusted (or fine-tuned) by additional factors that are known and available prior to the opening of the new store. The process 200 then involves calculating a second estimate based on real time inventory data from the new store immediately after opening of the store. The estimate of inventory demand generally involves a number of estimates of a desirable quantity of merchandise items at the new store.

At block 202, demographic and/or geographic data are collected and stored for a new store. For example, the data may indicate that the population neighboring the new store has a certain age, income, and/or educational graphical distribution, such as a high proportion of young, educated, and/or high income individuals. It is desirable to collect such demographic and/or geographic data to make predictions regarding the types and quantities of merchandise likely to be purchased. Once the data is gathered, it may be sorted or filtered by any one of these variables (such as age) or combination of variables.

At block 204, demographic, geographic, and historic sales data are collected and stored for existing stores. It is generally contemplated that the same types of demographic and/or geographic variables are collected and stored as were collected and stored for the new store. By collecting and storing the same types of data, it is generally easier to compare the new store to existing stores to determine a close match. In addition, past sales data are collected and stored for the existing stores. As should be evident, the order of the steps in process 200 may be in a different sequence. It is likely that the data for existing stores will be collected and stored before the data for the new store.

At block 206, real time inventory data for sales of merchandise items at the new store are determined for a certain time period immediately after opening of the new store. In one form, it is contemplated that this inventory data may be gathered by any of a variety of sensors (weight/pressure sensors, camera/video apparatuses, robots, etc.) and/or may be gathered by data from point of sales registers or equipment. Inventory data for various merchandise items may be collected based on some combination of sensor and sales data, and sensor and sales data may be gathered redundantly to verify the inventory determinations. Further, it is generally contemplated that this real time inventory data is collected within a short time period (i.e., a week or a few days) after opening of the new store.

At block 208, the demographic and/or geographic data of the new and existing stores is accessed and compared. This comparison can be accomplished in various ways. In one form, one variable (such as age) may be selected, and the comparison may be based solely on this one variable. So, the comparison would seek to determine a close match to the age distribution of the area neighboring the new store. In another form, several variables may be selected, and the comparison may be based on these multiple variables. These variables may be given even or differing weights. For example, the variables may be weighted so that the comparison may emphasize one variable (such as income) but may also include a second variable given lesser weight (such as age). It should be understood that the comparison may be made on some desired subset of the demographic and/or geographic data collected and stored.

At block 210, existing store(s) with certain demographic and/or geographic data are identified. In other words, a close match to the new store is identified. This close match may be limited to just one existing store or may be multiple existing stores. In one form, any of various statistical approaches may be used to determine a close match of a distribution (such as an age distribution) of the new store to existing store(s).

At block 212, sales for merchandise item(s) at the identified existing store(s) are determined. Once a close match of one or more existing stores has been determined, the historic or sales of merchandise items at these identified existing store(s) can be used as a basis for the inventory demand at the new store. In one form, it is generally contemplated that this historic or past sales data is stored in and accessible from an existing store database or from a separate database associated with the existing store database. At block 214, a first estimate of inventory demand for merchandise items at the new store is determined based on past/historic sales at the existing store(s).

At block 216, the first estimate may be adjusted based on such factors as nearby competing or non-competing stores, general market, sales trends, seasonality, the distribution network of the new store, and/or the physical size of the new store. For instance, as a first factor, nearby stores may be known for selling a certain type of merchandise (such as grocery), so the first estimate with respect to grocery merchandise might be adjusted downward. This adjustment may be made with respect to other retail stores that are deemed to be in competition with the new store, as well as other retail stores that may not be considered to be in direct competition. Second and third factors include general market and sales trends. Certain types of merchandise may be known to be especially popular to consumers based on recent trends (such as pop culture trends). A fourth factor is seasonality, and the first estimate for certain types of merchandise may be adjusted based on the current or upcoming season (such as warm garments in winter). A fifth factor is the distribution network of the new store. The inventory of certain types of merchandise may be adjusted downward if distribution to the new store can be made quickly, while other types of merchandise may be adjusted upward if distribution of this type of merchandise is difficult and/or slow. A sixth factor is the physical size of the new store. For instance, if the new store is a large store that can accommodate more inventory and more customers, the first estimate might be increased. As should be evident, the first estimate may be adjusted based on a combination of some or all of these factors.

At block 218, a second estimate of inventory demand is calculated based on the real time inventory data at the new store. This recalculation is intended to allow the consideration of real time feedback immediately after the new store opens. So, for example, if the sales of a certain type of merchandise item in the first few days is twice as much as was anticipated, the second estimate might be recalculated as twice as much as the first estimate. On the other hand, if the sales are half as much, the second estimate might be recalculated as half of the first estimate. Given the uncertainty of sales associated with the new store, this real time feedback provides a quick and important safeguard on inventory to prevent the accumulation of either too much or too little inventory for various types of merchandise.

At block 220, shipments of merchandise may be adjusted based on the second estimate. It is generally contemplated that a number of actions can be taken in response to the second estimate (which includes the feedback of real time inventory data at the new store). One of these actions is the possible redirecting or rerouting of shipments in the process of being delivered. For example, based on the first estimate, shipments of various types of merchandise may be on the way at the time or shortly after opening of the new store. On the one hand, if the second estimate is an increase over the first estimate for certain merchandise, the second estimate may suggest that an increased quantity of certain types of merchandise (an increased inventory demand) are desired at the new store. In response, the retailer may reroute or redirect some merchandise shipments to the new store. On the other hand, if the second estimate is a decreased from the first estimate for certain merchandise, the second estimate may suggest that a decreased quantity of certain types of merchandise are desirable. In response, the retailer may reroute or redirect some merchandise shipments from the new store to other stores.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for determining and adjusting initial inventory requirements at new shopping facilities based on real time sales, the system comprising:
at least one of a point of sale interface or a plurality of sensors arranged about a new shopping facility configured to determine changes in the quantities of a plurality of predetermined merchandise items in the new shopping facility within a predetermined time period being less than a week after opening of the new shopping facility, the plurality of sensors including weight sensors at merchandise shelves or optical or imaging sensors;
a new shopping facility database including demographic and geographic information corresponding to the area about the new shopping facility;
an existing shopping facility database including demographic, geographic, and sales information corresponding to existing shopping facilities;
a central computing system communicatively coupled to the new shopping facility and existing shopping facility databases, the central computing system configured to:
access the demographic and geographic information corresponding to the new shopping facility and corresponding to the existing shopping facilities;
compare the demographic and geographic information corresponding to the new shopping facility with the demographic and geographic information corresponding to existing shopping facilities;
identify at least one existing shopping facility with similar demographic and geographic information to the new shopping facility;
determine the sales for the plurality of predetermined merchandise items at the at least one existing shopping facility;
calculate a first determination of inventory requirement for the plurality of predetermined merchandise items at the new shopping facility based on the sales determination;
determine real time inventory information based on the changes in the quantities of the plurality of predetermined merchandise items at the new shopping facility within the predetermined time period after opening of the new shopping facility;
calculate a second determination of inventory requirement for the plurality of predetermined merchandise items at the new shopping facility based on the real time inventory information; and
instruct an increase or decrease in incoming shipments of inventory for at least one of the plurality of predetermined merchandise items based on the real time inventory information.

2. The system of claim 1, wherein the existing shopping facility database includes information from a plurality of shopping facilities corresponding to one retail sales entity.

3. The system of claim 1, wherein the central computing system is configured to adjust the first determination based on the sales of at least one of competing and non-competing shopping facilities in the geographic region about the new shopping facility.

4. The system of claim 1, wherein the central computing system is configured to adjust the first determination based on at least one of the general market, sales trends, and seasonal inventory demands for the geographic region about the new shopping facility.

5. The system of claim 1, wherein the central computing system is configured to adjust the first determination based on the distribution network for delivery of merchandise items for the geographic region about the new shopping facility.

6. The system of claim 1, wherein the central computing system is configured to adjust the first determination based on the physical size of the new shopping facility.

7. The system of claim 1, wherein the predetermined time period after opening of the new shopping facility is three days or less.

8. The system of claim 1, wherein the calculation of the second determination comprises adjusting the first determination based on the sales of the plurality of merchandise items at the new shopping facility within the predetermined time period after opening of the new shopping facility.

9. The system of claim 8, wherein the central computing system is configured to, if the second determination is greater than the first determination, instruct an increase of incoming shipments of inventory for the at least one of the plurality of predetermined merchandise items.

10. The system of claim 8, wherein the central computing system is configured to, if the second determination is less than the first determination, instruct a reduction of incoming shipments of inventory for the at least one of the plurality of predetermined merchandise items.

11. A method for determining and adjusting initial inventory requirements at new shopping facilities based on real time sales, the method comprising:
storing in a new shopping facility database demographic and geographic information corresponding to the area about a new shopping facility;
storing in an existing shopping facility database demographic, geographic, and historic sales information corresponding to existing shopping facilities;
providing at least one of a point of sale interface or a plurality of sensors arranged about the new shopping facility, the plurality of sensors including weight sensors at merchandise shelves or optical or imaging sensors;
determining changes in the quantities of a plurality of predetermined merchandise items in the new shopping facility within a predetermined time period being less than a week after opening of the new shopping facility;
by a central computing system:
accessing the demographic and geographic information corresponding to the new shopping facility and corresponding to the existing shopping facilities;
comparing the demographic and geographic information corresponding to the new shopping facility with the demographic and geographic information corresponding to existing shopping facilities;
identifying at least one existing shopping facility with similar demographic and geographic information to the new shopping facility;
determining the historic sales for the plurality of predetermined merchandise items at the at least one existing shopping facility;
calculating a first determination of inventory requirement for the plurality of predetermined merchandise items at the new shopping facility based on the historic sales determination;
determining real time inventory information based on the changes in the quantities of the plurality of predetermined merchandise items at the new shopping facility within the predetermined time period after opening of the new shopping facility;
calculating a second determination of inventory requirement for the plurality of predetermined merchandise item at the new shopping facility based on the real time inventory information; and
instructing an increase or decrease in incoming shipments of inventory for at least one of the plurality of predetermined merchandise items based on the real time inventory information.

12. The method of claim 11, wherein the existing shopping facility database includes information from a plurality of shopping facilities corresponding to one retail sales entity.

13. The method of claim 11, further comprising, by the central computing system, adjusting the first determination based on the sales of at least one of competing and non-competing shopping facilities in the geographic region about the new shopping facility.

14. The method of claim 11, further comprising, by the central computing system, adjusting the first determination based on at least one of the general market, sales trends, and seasonal inventory demands for the geographic region about the new shopping facility.

15. The method of claim 11, further comprising, by the central computing system, adjusting the first determination based on the distribution network for delivery of merchandise items for the geographic region about the new shopping facility.

16. The method of claim 11, further comprising, by the central computing system, adjusting the first determination based on the physical size of the new shopping facility.

17. The method of claim 11, wherein the predetermined time period after opening of the new shopping facility is three days or less.

18. The method of claim 11, wherein the step of calculating the second determination comprises adjusting the first determination based on the sales of the plurality of merchandise items at the new shopping facility within the predetermined time period after opening of the new shopping facility.

19. The method of claim 18, further comprising, by the central computing system, if the second determination is greater than the first determination, instructing an increase of incoming shipments of inventory for the at least one of the plurality of predetermined merchandise items.

20. The method of claim 18, further comprising, by the central computing system, if the second determination is less than the first determination, instructing a reduction of incoming shipments of inventory for the at least one of the plurality of predetermined merchandise items.
